(19) United States
(12) Patent Application Publication
(10) Pub. No.: US 2018/0356043 A1
(43) Pub. Date: Dec. 13, 2018

(54) Tap Cover For A Gas Cylinder

(71) Applicant: Luxembourg Patent Company S.A., Lintgen (LU)

(72) Inventors: Morgan Lamiable, Metzervisse (FR); Jean-Claude Schmitz, Heisdorf (LU)

(21) Appl. No.: 15/776,670

(22) PCT Filed: Nov. 14, 2016
(86) PCT No.: PCT/EP2016/077570

§ 371 Date: May 16, 2018

(30) Foreign Application Priority Data
Nov. 16, 2015 (LU) 92876

(51) Int. Cl. F17C 13/06; F17C 13/08

(52) U.S. Cl. CPC F17C 13/06; F17C 13/084; F17C 2205/0308; F17C 2203/0617; F17C 2201/0128; F17C 2223/0123; F17C 2205/0329

(57) ABSTRACT

A gas storage assembly. The assembly comprises a gas cylinder, a tap fixed to the gas cylinder, a cover with a shell protecting and housing the tap. The shell includes a front face with a hand-wheel and connecting plugs, a rear face on the opposite of the front face, a first element, and a second element. The rear face comprises a rear opening formed in both the first element and the second element which are an upper half shell and a lower half shell respectively. A rear closure part closes the rear opening and is removably mounted to the lower half shell and to the tap. The opening provides a wide view for mounting and testing the tap when mounted to the gas cylinder.

### CROSS-REFERENCE TO RELATED APPLICATIONS

The present invention is the US national stage under 35 U.S.C. § 371 of International Application No. PCT/EP2016/077570, which was filed on Nov. 14, 2016, and which claims the priority of application LU 92876 filed on Nov. 16 2015, the content of which (text, drawings and claims) are incorporated here by reference in its entirety.

### FIELD

The invention is directed to a cover for a tap on a gas cylinder. The invention also concerns a gas storage assembly comprising a gas cylinder, a tap and a cover on the tap.

### BACKGROUND

Prior art patent document published WO2015/132092A2 discloses a cover for a tap of a gas cylinder. The cover includes a spherical shell housing the tap. The shell is essentially constituted of two halves, namely a lower shell and an upper shell. The halves are joined along a contact plane which is inclined with respect to the vertical axis. This compact architecture is peculiarly interesting since it reduces the manufacturing and assembly costs. However, the mounting of the tap on its gas cylinder remains complicated. Pre-settings and leakage tests stand tricky.

### SUMMARY

The invention aims at providing a cover for a tap gas cylinder solving at least one of the problems stated in the prior art. The invention also has for technical problem to provide a tap cover easing the mounting of the tap on its gas cylinder. The invention also aims at providing an easy, rugged and cost saving solution.

The invention is directed to a cover for a tap of a gas cylinder, the cover comprising a shell intended to house the tap, the shell including: a first element; a second element; a front face, notably with a hand-wheel; a rear face on the opposite of the front face; wherein the rear face comprises a rear opening which is formed in at least one of the shell elements and which is intended to provide an access to the tap; and the shell comprises a removable rear closure closing the rear opening.

According to various embodiments, the rear closure is removably mounted to the shell, in various instances the shell is generally spherical.

According to various embodiments, the shell comprises a joining interface between the first element and the second element, the rear closure crossing the joining interface.

According to various embodiments, the joining interface is a joining surface, notably a joining plane, the joining surface generally forming an angle comprised between 30° and 60°, in various instances between 40° and 50° with the vertical axis.

According to various embodiments, the rear closure comprises two main portions which are generally inclined with respect of each other, in various instances the main portions comprises a flat portion and/or a spherical portion.

According to various embodiments, the rear closure comprises an arcuate lower edge, in various instances the lower edge essentially forms a semi-circle.

According to various embodiments, the rear closure is in contact with the first element and with the second element, in various instances the first element and the second element each comprise cut-outs matching with the outline of the rear closure.

According to various embodiments, the first element forms a first half shell, in various instances an upper half shell, and/or the second element forms a second half shell, in various instances a lower half shell.

According to various embodiments, the first element is an upper element, and the second element is a lower element, in various instances the cover comprises an upper handle above the upper element.

According to various embodiments, the upper handle comprises a battery intended to provide electrical power to the tap; in various instances the handle generally extends horizontally.

According to various embodiments, the first element and the second element are the main elements of the shell; in various instances their combination, optionally with a hook, forms the majority, in various instances at least 70%, in various other instances at least 80%, of the outer surface of the shell or of a sphere.

According to various embodiments, the upper handle and the joined shell element, notably the upper half shell, forms a one piece part; in various instances an integrally formed part.

According to various embodiments, the rear closure extends over the majority of the height of the shell; and/or forms a wall, and or a shutting screen.

According to various embodiments, the portions of the rear closure are inclined of at least 10° with respect of each other, in various instances at least 20°, in various other instances at least 40°.

The invention is also directed to a cover for a tap of a gas cylinder, the cover comprising: a front face intended to receive a hand-wheel; a rear face on the opposite of the front face; a shell intended to house the tap, the shell including a first element and a second element; wherein the cover further comprises a rear closure removably mounted, notably to the shell, in order to provide an access to the tap.

The invention is also directed to an assembly comprising a tap for a gas cylinder and a cover; wherein the cover is in accordance with the invention, in various instances the tap comprises a tap body with at least one gas passageway.

According to various embodiments, the rear closure and/or the first element comprise a flange engaging with the tap, in various instances the tap body comprises an annular groove wherein the flanges engage.

According to various embodiments, the tap comprises a pressure reducer with a pre-setting device which faces the rear closure, in various instances the rear closure comprises a tubular portion encircling the pre-setting device.

According to various embodiments, the rear closure comprises an inner stiffened portion, which in various instances extends over the majority of height of the rear closure; and/or which forms the flange and/or the tubular portion of the rear closure.

According to various embodiments, the tap body comprises a lower threaded portion intended to be screwed to a gas cylinder, and a holding portion for screwing the threaded portion; the holding portion vertically levels the rear closure, in various instances the holding portion faces the rear opening.

According to various embodiments, the tap comprises an electrical plug inside the shell, the rear closure overlaying the electrical plug in the assembly state of the rear closure.

According to various embodiments, the assembly comprises a gas cylinder with a neck portion where the tap is fixed, the cover being remote from the gas cylinder, in various instances the assembly comprises a separating interface separating the cover from the gas cylinder.

According to various embodiments, the first element and the second element are each fixed to the tap.

According to various embodiments, the tap forms a link in contact of the flanges of the rear closure and of the first element; in various instances the flanges are on opposite faces of the tap.

According to various embodiments, the second element comprises a lower hole with a vertical axis and which is crossed by the tap.

According to the invention, each feature of each cover and of the assembly can be freely combined with each cover and with the assembly.

The invention is particularly interesting in that it forms a cover which protects the tap and which also provides a wide rear opening. This opening becomes useful for assembling the tap to a gas cylinder. The tap can easily be mounted even if the halves of the shell already encage the tap.

The opening provides a wide area for controlling the tap. After mounting, leakage tests are still uncomplicated to run. The safety of the corresponding assembly is improved. The opening is added, but maintains the stiffness of the cover in a way to preserve the tap protection.

### DRAWINGS

FIG. 1 is a perspective view of a cover for a tap of a gas cylinder according to various embodiments of the invention.

FIG. 2 illustrates a section of the the cover of FIG. 1 along the vertical axis and the longitudinal axis, according to various embodiments of the invention.

FIG. 3 represents a perspective view of the cover of the FIGS. 1 and 2 where the rear closure has been removed in order to show the tap, according to various embodiments of the invention.

FIG. 4 shows the insertion of a tool in the opening of the shell of FIGS. 1, 2 and 3, according to various embodiments of the invention.

### DESCRIPTION

In the following description, the vertical axis corresponds to the superposition direction of the tap on a gas cylinder, and/or to the main axis of the gas cylinder. The longitudinal axis extends from the front face to the rear face and is horizontal. The transverse axis is perpendicular to both previous axes.

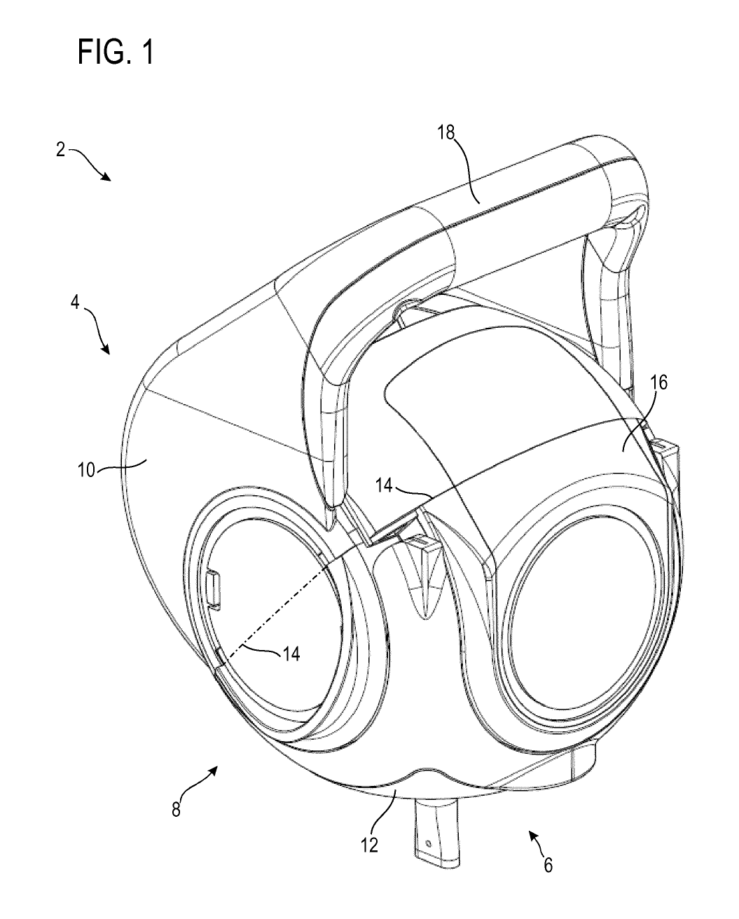

FIG. 1 is a perspective view of the assembly 2 in accordance with various embodiments of the invention. The assembly is represented from its rear face, or back face.

The assembly 2 comprises a cover 4 and a tap 6 arranged in the cover 4 in order to protect it. The assembly 2 optionally comprises a gas cylinder (not represented). The tap 6 can control the gas flow, and/or the outlet pressure. The gas cylinder can be fixed to a lower threaded portion of the tap 6. The gas cylinder can contain high pressurized gas, for example with a pressure of at least 100 bars, for example of at least 200 bars. The gas can be argon or oxygen. The assembly 2 can be understood as a gas storage assembly.

The cover 4 has a shell 8 which generally has a spherical shape. This spherical shape can however show flat portions, for instance side flats. The cover 4 comprises a front face and a rear face, which are formed on the shell 8. The front face can include a user interface, such as a hand-wheel; for instance for adjusting the outlet pressure and/or the flow rate of the gas distributed by the tap 6. The front face optionally includes gas supply and/or connectors for connecting gas hoses. The cover 4 wraps, at least partially, the tap 6. The latter can comprise a body, in various instances a main body, which is located in the housing formed by the shell 8. The tap 6 can remain hidden in the shell 8. The majority of or all the shell body can be in the shell 8.

The shell 8 can essentially comprise two main elements (10; 12), namely a first element 10 and a second element 12. Each of them forms a half shell. They can be an upper half shell 10 and a lower half shell 12 respectively. The halves (10; 12), are fixed together by four screws. Their joining interface 14 is generally an inclined plane which forms an angle of about 45° with the vertical axis. The interface 14 can also be a curved surface, like a bent sheet.

The elements (10; 12), exhibit cut-outs forming a rear opening in the rear face of the shell 8. The shell comprises a rear closure part 16 arranged in the opening in order to close it. This rear closure part 16 is flush with the outer surface of the upper half shell 10 and of the lower half shell 12. The rear closure 16 can extend over the majority of the height and/or of the width of the shell 8. It can join each half shell (10; 12), and forms a mechanical link. The rear closure 16 has an upper edged which is slightly curved, and a lower edge which forms a half circle. These edges conform to the opening in order to shut it. Alternatively, the opening of the shell can be embraced by a single half shell.

The cover 4 can comprise a handle 18, an upper handle for instance. The handle 18 can also be located backwards, in order to provide more space for the hand-wheel or any equipment. The handle 18 comprises a horizontal bar, and two side links that project vertically from the horizontal bar to the upper half shell. The handle 18 and the upper half shell 10 can form a single part, for instance manufactured by moulding.

The upper half shell 10, the lower half shell 12 and the rear closure part 16 can comprise polymer. They can be manufactured of composite material, with an organic matrix and fibres for instance. Some additives can be used in the matrix.

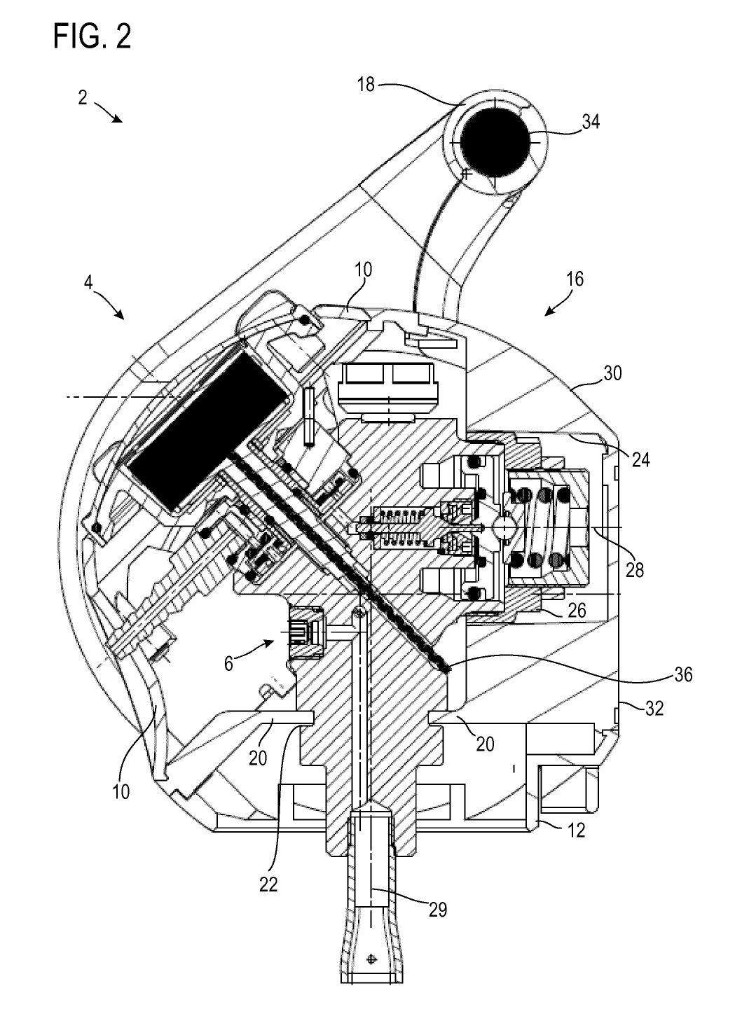

FIG. 2 is a section of the assembly 2 according to various embodiments of the invention. The section is taken according to a vertical plane which also includes the longitudinal axis 28 and the vertical axis 29. The tap body comprises several passageways for a gas flow provided by the gas cylinder.

The rear closure 16 and the upper half shell 10 each comprise a contact flange 20. Both flanges extend horizontally toward each other, and toward the tap 6. The horizontal flanges 20 pinch the tap 6. The tap body optionally includes a peripheral annular groove 22 wherein the flanges 20 engage. Due to this arrangement, the flanges 20 vertically secure the cover 4 to the tap 6, and improve the rigidity of the assembly. The tap 6 is protected in a safer fashion.

The rear closure 16 can comprise an inner stiffener portion essentially extending over the whole height of the rear closure 16. The stiffener portion can extend inwardly, toward the tap 6. The stiffener portion can include a tubular portion 24. The pre-setting device 26 of the pressure reducer can be inserted in the tubular portion 24, and can be blocked therein. The tubular portion 24 fosters a mounting of the rear closure 16 along the longitudinal axis 28.

The rear closure 16 comprises two main portions (30; 32), an upper portion 30 and a lower portion 32. The upper portion 30 can be located in the upper half shell 10, whereas the lower portion 32 can be surrounded by the lower half shell 12. These portions (30; 32) can be inclined of at least 30° with respect to each other, for instance due to the flat shape of the lower portion 32. The latter can be generally flat. The upper portion 30 can reproduce the spherical shape of the first element 10.

The handle 18 can enclose a battery 34, useful for powering gauges, probes, or various equipment of the tap 6 as a display. A wiring can extend rearward, and end in the rear side with a plug 36 or a socket. The plug 36 can face the rear closure 16, which means that the removal of the rear closure 16 gives access to the plug 36.

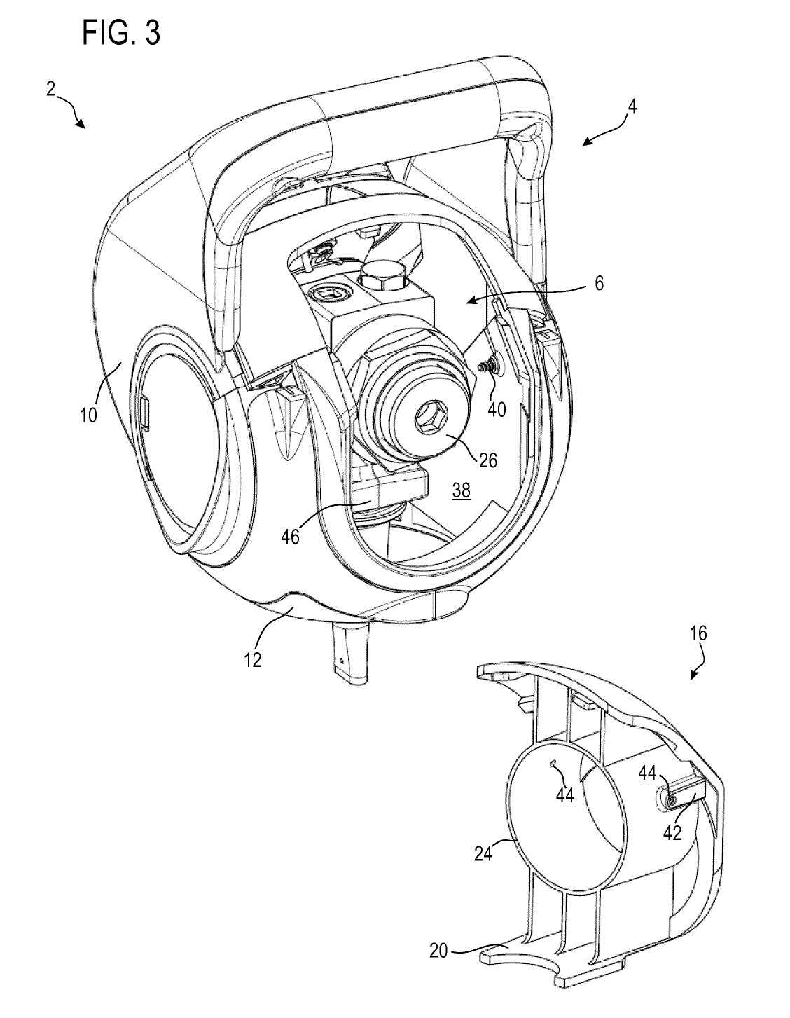

FIG. 3 illustrates the assembly 2 where the rear closure 16 is apart from the upper half shell 10 and the lower half shell 12. There, the rear of the tap 6 emerges through the rear opening 38. The pre-setting device 26 emerges in the middle of the rear opening 38. The rear closure 16 is turned with respect to its assembly orientation in order to show the tubular portion 24 and the flange 20.

The rear closure 16 is removable. It is detachable. It can be fixed to the shell by reversible parts 40, like screws. Two lateral screws can be used for securing the rear closure to the shell 4. Only one lateral screw 40 can be seen. It projects transversally inside the housing formed by the shell 4. The rear closure 16 can comprise two corresponding fixation tongues 42 with corresponding holes 44 wherein the screws can be screwed. These screws can also be used for fixing an optional hook (not represented). Such a hook can be a pivoting hook for hanging the assembly to a horizontal bed bar. The hook can be integrated in the lower half shell.

The tap body can include a holding portion 46. This portion 46 affords a rotation lock. It can exhibit a square portion, or a hexagonal portion. It is encircled by flat faces useful for a clamping tool. The holding portion 46 is situated in front of the rear opening 38; it can be hidden by the rear closure 16 in the assembly state or closed state.

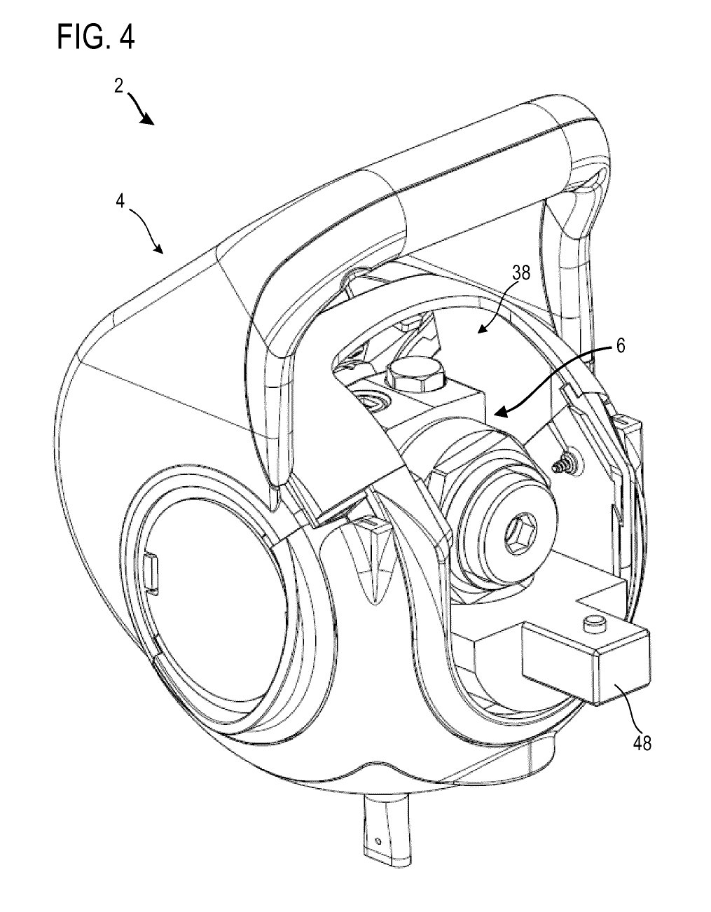

FIG. 4 illustrates a perspective view of the assembly 2 of FIGS. 1 to 3. The cover 4 is represented in a disassembly state, where the rear closure is removed.

There, the rear opening 38 is fully opened, and a mounting tool 48 is introduced there through. The clamping tool 48 can comprise a yoke or a fork embracing the square portion of the tap. The tool 48 can exert a sufficient torque for screwing and tighten the tap 6 on a gas cylinder. The rear opening is convenient since it is broad enough for a longitudinal insertion of a tool 48.

1-17. (canceled)

18. A cover for a tap of a gas cylinder, the cover comprising a shell for housing the tap, said shell including:
a first element;
a second element;
a front face including a hand-wheel;
a rear face on the opposite of the front face, wherein the rear face comprises a rear opening that is formed in at least one of the first and second shell elements, and is structured and operable to provide an access to the tap; and
a removable rear closure closing the rear opening.

19. The cover according to claim 18, wherein the rear closure is removably mounted to the shell and the shell is generally spherical.

20. The cover according to claim 18, wherein the shell comprises a joining interface between the first element and the second element, the rear closure crossing the joining interface.

21. The cover according to claim 20, wherein the joining interface is a joining plane, the joining plane generally forming an angle comprised between 30° and 60° with the vertical axis.

22. The cover according to claim 18, wherein the rear closure comprises two main portions that are generally inclined with respect of each other, the main portions comprise a flat portion and/or a spherical portion.

23. The cover according to claim 18, wherein the rear closure comprises an arcuate lower edge, the lower edge essentially forming a semi-circle.

24. The cover according to claim 18, wherein the rear closure is in contact with the first element and with the second element, the first element and the second element each comprise cut-outs matching with the outline of the rear closure.

25. The cover according to claim 18, wherein at least one of the first element forms a first half shell and the second element forms a second half shell.

26. The cover according to claim 18, wherein the first element is an upper element, and the second element is a lower element, the cover comprising an upper handle above the upper element.

27. The cover according to claim 26, wherein the upper handle comprises a battery structured and operable to provide electrical power to the tap, the handle extending horizontally.

28. An assembly comprising a tap for a gas cylinder and a cover; wherein the cover comprises a shell for housing the tap, said shell including:
a first element;
a second element;
a front face including a hand-wheel;
a rear face on the opposite of the front face, wherein the rear face comprises a rear opening which is formed in at least one of the first and second shell elements, and that is structured and operable to provide an access to the tap; and
the shell comprises a removable rear closure closing the rear opening.

29. The assembly according to claim 28, wherein at least one of the rear closure and the first element comprise a flange engaging with the tap, the tap body comprising an annular groove wherein the flanges engage.

30. The assembly according to claim 28, wherein the tap comprises a pressure reducer with a pre-setting device which faces the rear closure, the rear closure comprising a tubular portion encircling the pre-setting device.

31. The assembly according to claim 28, wherein the rear closure comprises an inner stiffener portion that at least one of extends over the majority of height of the rear closure, and forms the flange and the tubular portion of the rear closure.

32. The assembly according to claim 28, wherein the tap body comprises a lower threaded portion the to be screwed to a gas cylinder, and a holding portion for screwing the threaded portion, the holding portion vertically levels the rear closure, the holding portion facing the rear opening.

33. The assembly according to claim 28, wherein the tap comprises an electrical plug inside the shell, the rear closure overlaying the electrical plug in the assembly state of the rear closure.

34. The assembly according to claim 28, comprising a gas cylinder with a neck portion where the tap is fixed, the cover being remote from the gas cylinder, the assembly comprising a separating interface separating the cover from the gas cylinder.
